(19) United States
(12) Patent Application Publication
(10) Pub. No.: US 2025/0274610 A1
(43) Pub. Date: Aug. 28, 2025

(54) ICC PROFILE METADATA FOR VIDEO STREAMS

(71) Applicant: Tencent America LLC, Palo Alto, CA (US)

(72) Inventors: Arianne HINDS, Palo Alto, CA (US); Stephan WENGER, Palo Alto, CA (US)

(21) Appl. No.: 19/061,900

(22) Filed: Feb. 24, 2025

Related U.S. Application Data
(60) Provisional application No. 63/558,070, filed on Feb. 26, 2024.

(51) Int. Cl. H04N 19/70

(52) U.S. Cl. CPC H04N 19/70

(57) ABSTRACT

An example method of video decoding includes receiving a video bitstream comprising a set of pictures, the video bitstream corresponding to a source device. The method also includes identifying color profile metadata for the source device based on a supplementary enhancement information (SEI) message for the video bitstream, and reconstructing the set of pictures using information from the video bitstream. The method further includes causing the set of pictures to be presented at an output device using color characteristics from the color profile metadata.

### PRIORITY

This application claims priority to U.S. Provisional Patent Application No. 63/558,070, entitled “ICC Profile Metadata for Video Streams,” filed Feb. 26, 2024, which is hereby incorporated by reference in its entirety.

### TECHNICAL FIELD

The disclosed embodiments relate generally to video coding, including but not limited to systems and methods for incorporating color profile metadata in video bitstreams and using the color profile metadata for video reconstruction.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released. Enhanced Compression Model (ECM) is a video coding standard that is currently under development. ECM aims to significantly improve compression efficiency beyond existing standards like HEVC/H.265 and VVC, essentially allowing for higher quality video at lower bitrates.

Another technique used in video coding standards is the supplementary enhancement information (SEI) message which enables the carriage of information, within the coded bitstream, that is supplemental to the coded video. Such SEI information may or may not be directly related to the video coding process, i.e., as specified by the video standard. In some cases, the information in SEI messages is relevant to application processes that are executed in tandem with, or closely following, the video decoding process. Such applications can include a rendering process that uses certain SEI messages to adjust the brightness or color space of the decoded video frames prior to presentation by a display device. Another such application process arranges portions of the decoded video into a particular pattern as defined by an SEI message for 360 degree video, e.g., displayed on a head mounted. In general, a large number of applications can be supported through information provided in SEI messages.

For H.264, AVC, H.265, HEVC standards, SEI messages are specified in the main coding specifications, i.e., “Advanced Video Coding” and “High Efficiency Video Coding,” respectively. For H.266 and VVC. As an example, SEI messages that are strictly for use by applications may be specified in a separate specification entitled “Versatile supplemental enhancement information messages for coded video bitstreams” (VSEI), whereas SEI messages that can affect the decoding process may be specified in the main coding specification “Versatile video coding.” Additionally, the International Color Consortium develops profiles that aid in the management of color between different input and output devices.

### SUMMARY

The present disclosure describes, amongst other things, providing color profile metadata (e.g., International Color Consortium (ICC) profile metadata) in SEI messages. ICC profile specifications may be published by ISO, e.g., as ISO 15076. As an example, an input device (e.g., a digital camera) may use particular settings that describe the color characteristics used to capture raw Red, Green, and Blue image samples in images that are captured by the input device. These settings may be described in an ICC color profile used by the input device. The input device may store its ICC profile as metadata into the imagery that was captured by the camera. Likewise, an output device (e.g., a color printer) may have its own color characteristics which are also described in it ICC profile settings. Through the availability of an input device's ICC color profile that is stored in the metadata of the image captured, the output device may use the input device's ICC profile, and the output device's ICC profile to reconcile the color values used between the two devices (e.g., so that when the captured image is printed on the color printer, the fidelity of the color in the image is maintained). In a similar manner, a display device (another output device) may have its own ICC profile that describe the color characteristics of the display. In the presence of an ICC color profile for a camera used to capture an image, the display can more effectively manage the RGB colors when the image is displayed so that fidelity in the appearance of the image is maintained.

In accordance with some embodiments, a method of video decoding includes: (i) receiving a video bitstream (e.g., a coded video sequence) comprising a set of pictures, where the video bitstream corresponds to a source device; (ii) identifying color profile metadata for the source device based on a supplementary enhancement information (SEI) message for the video bitstream; (iii) reconstructing the set of pictures using information from the video bitstream; and (iv) causing the set of pictures to be presented at an output device using color characteristics from the color profile metadata.

In accordance with some embodiments, a method of video encoding includes: (i) receiving video data (e.g., a source video sequence) comprising a set of pictures corresponding to a source device; (ii) identifying color profile metadata for the source device; (iii) encoding and signaling the set of pictures in a video bitstream; and (iv) signaling the color profile metadata in a supplementary enhancement information (SEI) message for the video bitstream.

In accordance with some embodiments, a method of processing visual media data includes: (i) obtaining a source video sequence that comprises a set of pictures corresponding to a source device; (ii) identifying color profile metadata for the source device; and (iii) encoding the set of pictures in a video bitstream, where the video bitstream comprises the encoded set of pictures and a supplementary enhancement information (SEI) message that indicates the color profile metadata.

In accordance with some embodiments, a method of video processing comprises (i) setting an image format metadata type identifier to indicate that ICC profile metadata is included in an SEI message associated with a current image; (ii) signaling the image format metadata type identifier in a bitstream; and (iii) encoding the current image in the bitstream based on the image format metadata type identifier.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder). In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding. The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments.

FIG. 2B is a block diagram illustrating example elements of a decoder component in accordance with some embodiments.

FIG. 3 is a block diagram illustrating an example server system in accordance with some embodiments.

FIG. 4A illustrates an example NAL unit and SEI headers in accordance with some embodiments.

FIG. 4B illustrates an example generative AI post filtering process in accordance with some embodiments.

FIG. 4C illustrates an example capture system that embeds ICC profile metadata within an image in accordance with some embodiments.

FIG. 4D illustrates an example carriage of ICC profile metadata within the payload of an SEI message in accordance with some embodiments.

FIG. 4E illustrates an example reference of ICC profile metadata via a Uniform Resource Identifier (URI) within the payload of an SEI message in accordance with some embodiments.

FIG. 4F illustrates an example syntax of an ICC profile metadata SEI message in accordance with some embodiments.

FIG. 5A illustrates an example video decoding process in accordance with some embodiments.

FIG. 5B illustrates an example video encoding process in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes video/image compression techniques including signaling color profile metadata (e.g., ICC profile metadata) associated with source device in SEI messages for the video bitstream. Including the color profile metadata for the source device allows for the color characteristics of the source device to be taken into account at an output device, which can improve the fidelity/appearance of the video data.

### Example Systems and Devices

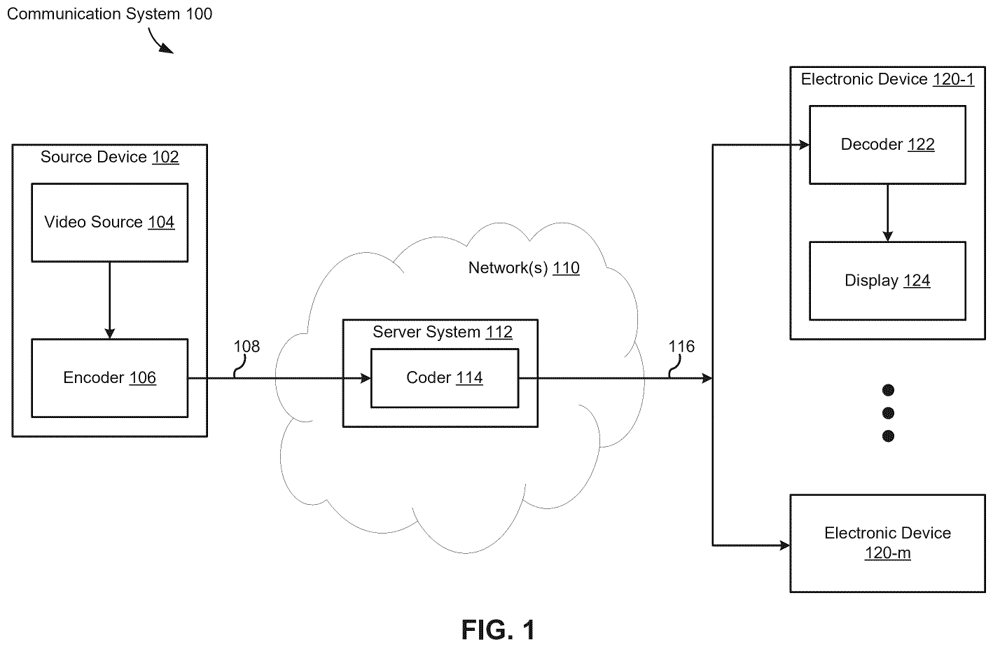

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prunc the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

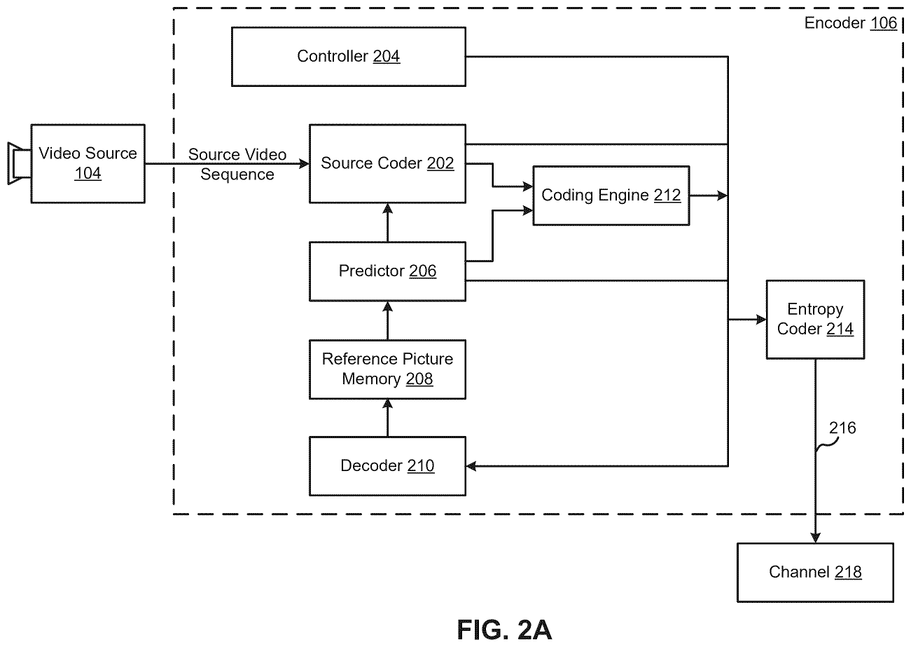

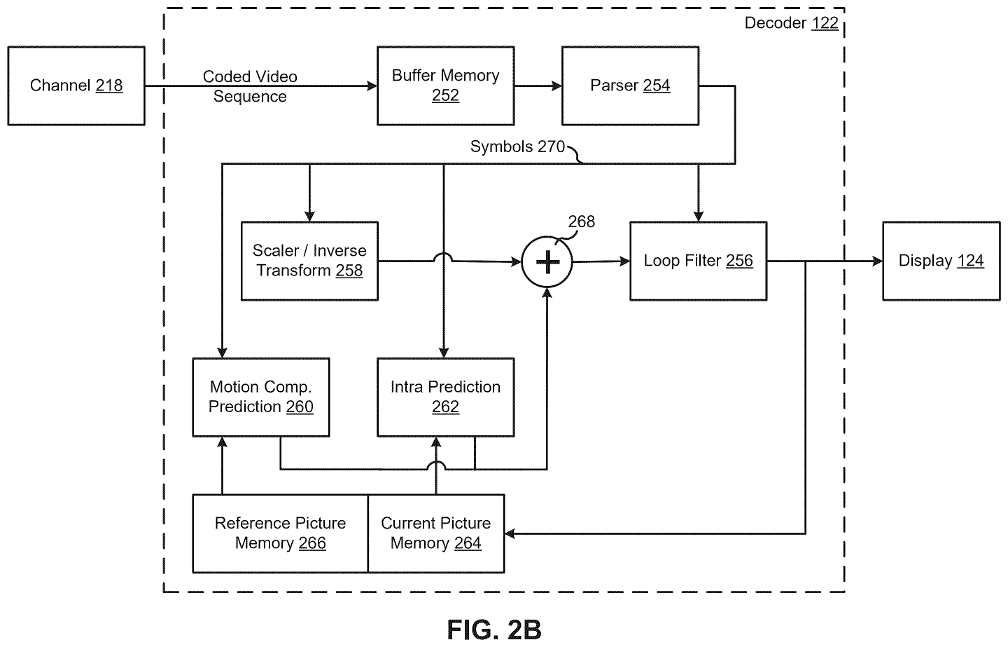

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. Additionally, the description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, for example, setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, for example, coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, e.g., temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, for example, information used to manage operation of the decoder component 122, and/or information to control a rendering device such as the display 124. The control information for the rendering device(s) may be in the form of, for example, Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268. In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, for example, X, Y, and reference picture components. Motion compensation may also include interpolation of sample values as fetched from the reference picture memory 266, e.g., when sub-sample exact motion vectors are in use, motion vector prediction mechanisms.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (by, for example, parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

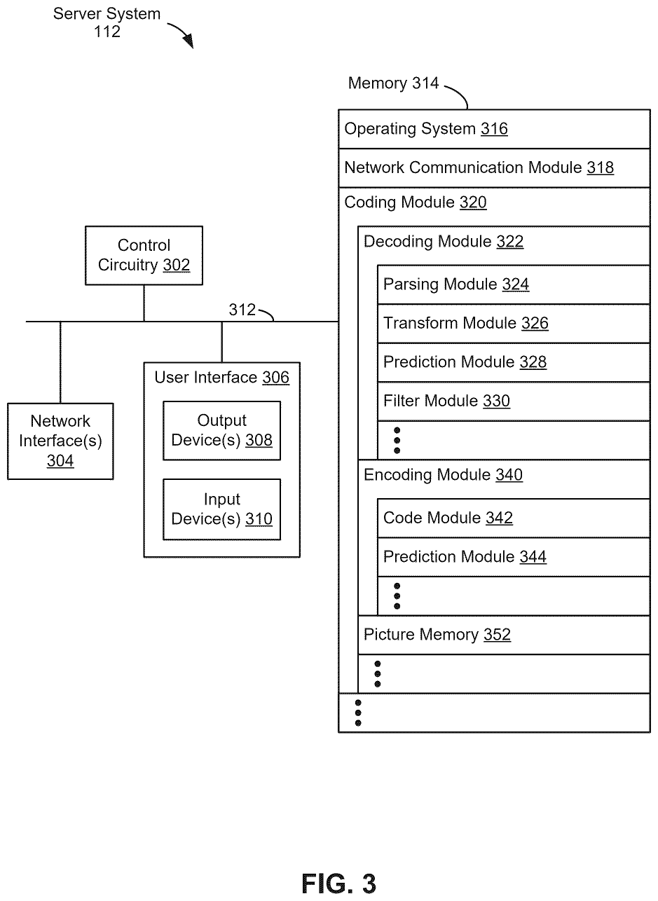

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes field-programmable gate array(s), hardware accelerators, and/or integrated circuit(s) (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above.

Although FIG. 3 illustrates the server system 112 in accordance with some embodiments, FIG. 3 is intended more as a functional description of the various features that may be present in one or more server systems rather than a structural schematic of the embodiments described herein. In practice, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

### Example Coding Techniques

The coding processes and techniques described below may be performed at the devices and systems described above (e.g., the source device 102, the server system 112, and/or the electronic device 120). As discussed previously, a video codec generally includes several aspects, including partitioning, intra/inter prediction, transform coding, quantization, entropy coding and in-loop filtering. Additionally, a video coder may include, signal, and/or parse additional data for a video bitstream. The additional data may include temporal, spatial, and/or SNR enhancement layers, other forms of redundant data such as redundant pictures and slices, supplementary enhancement information (SEI) messages, visual usability information (VUI) parameter set fragments, and the like. The discussion below relates to such additional data information provided with a video bitstream.

As described previously, SEI messages may be used to signal color profile metadata in video streams. The metadata may be stored directly into the payload of an SEI message according to the capabilities of the video coding standards, or as another alternative, an SEI message can be created with an information (e.g., a Uniform Resource Identifier (URI)) that identifies the ICC profile metadata resource to be obtained from a source external to the video bitstream.

A number of applications employ SEI messages, along with an associated coded video stream, to access metadata that are important/essential for the operation of the applications with video streams. One example is for stereoscopic video applications where a frame-packing SEI message describes the organization of left-eye vs. right-eye views for individual video frames that pack both views into a single frame. Another example application that relies on the carriage of metadata within an SEI message is Dolby Vision® which uses metadata carried in SEI messages to describe the transfer function to be applied to the input video signal by display systems capable of emitting high dynamic range outputs.

Emerging applications for generative artificial intelligence (AI) are also an area where SEI messages can facilitate the deployment of new services. In this application space, imagery along with corresponding supplemental information can be provided to one or more neural network models that create or “generate” a new or similar image-based result. An example of a popular, non-image-based, generative AI tool is ChatGPT. Adobe Firefly is an example of an image-based generative AI tool. However, for generative AI applications that rely on the imagery within a coded video stream, it is not practical to define separate SEI messages to address each of the nuanced inputs that the underlying models may require. An example of metadata that may be useful for generative AI (and other applications) is the information stored in ICC profile specifications, which may likewise be published by ISO as ISO 15076.

As discussed previously, compressed video can be augmented, e.g., in the corresponding video bitstream, by supplementary enhancement information, for example in the form of SEI messages or VUI. Video coding standards can include specifications parts for SEI and VUI. SEI and VUI information may also be specified in stand-alone specifications that may be referenced by the video coding specifications.

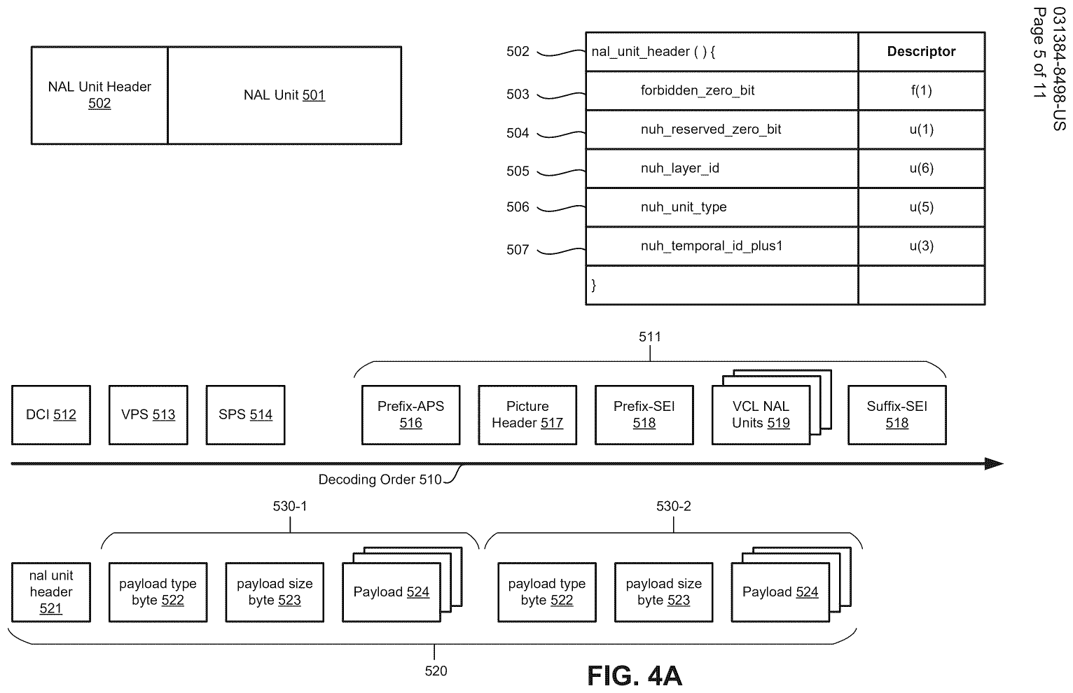

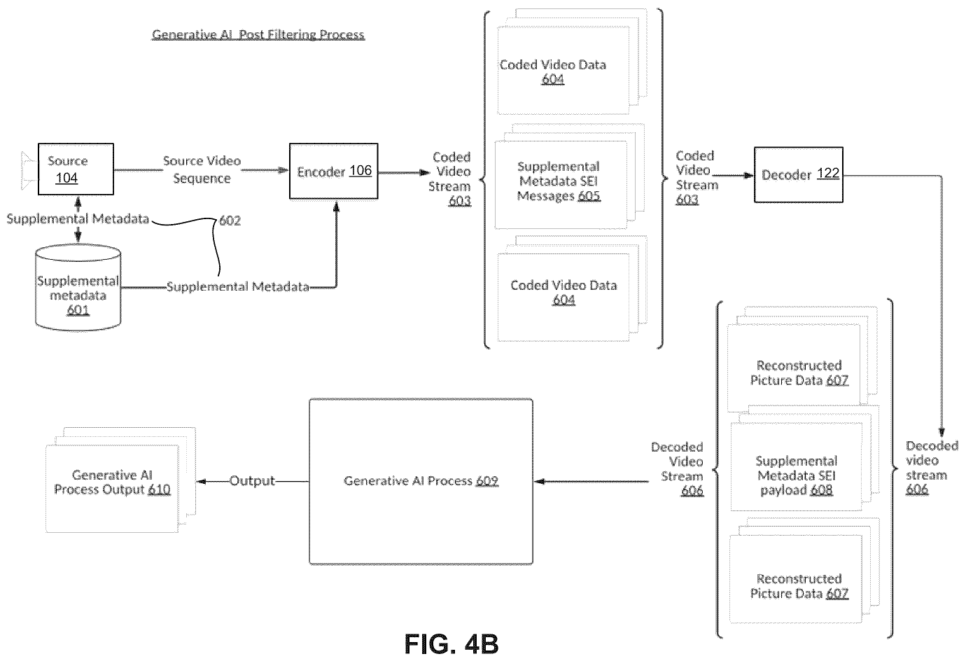

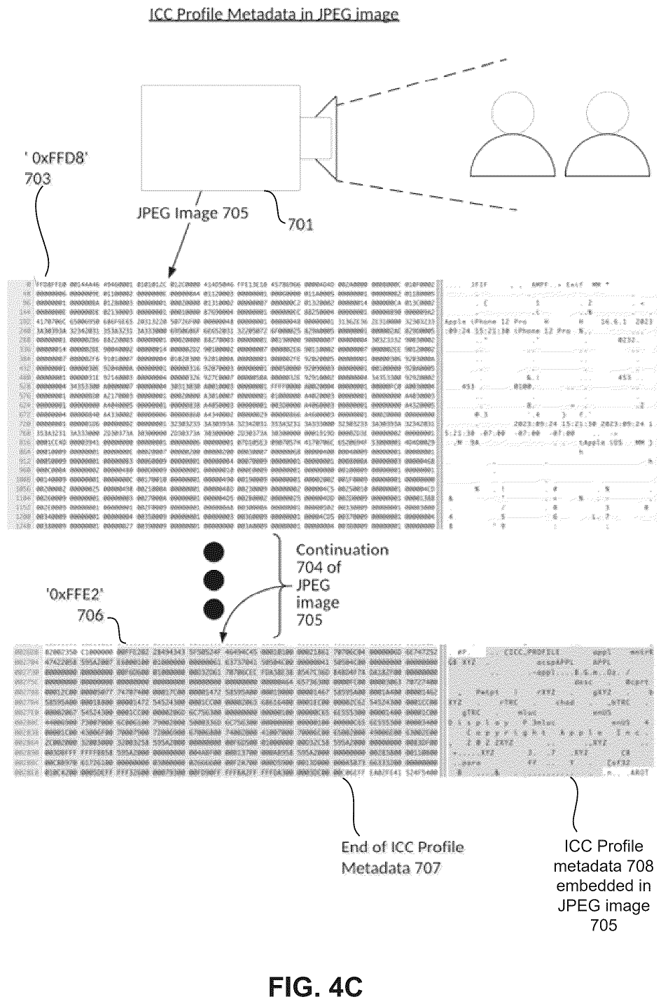

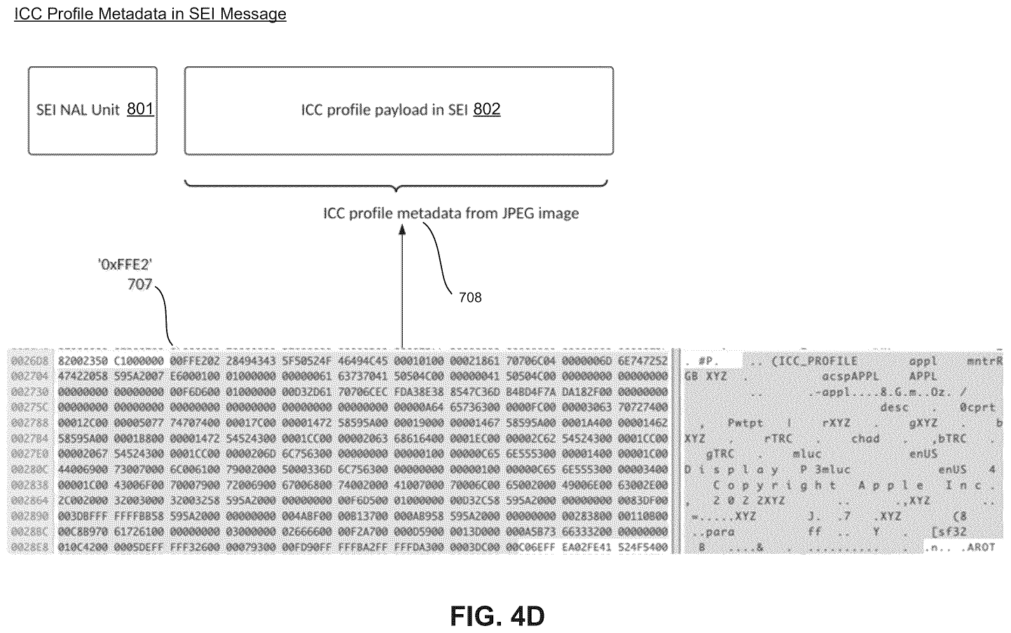

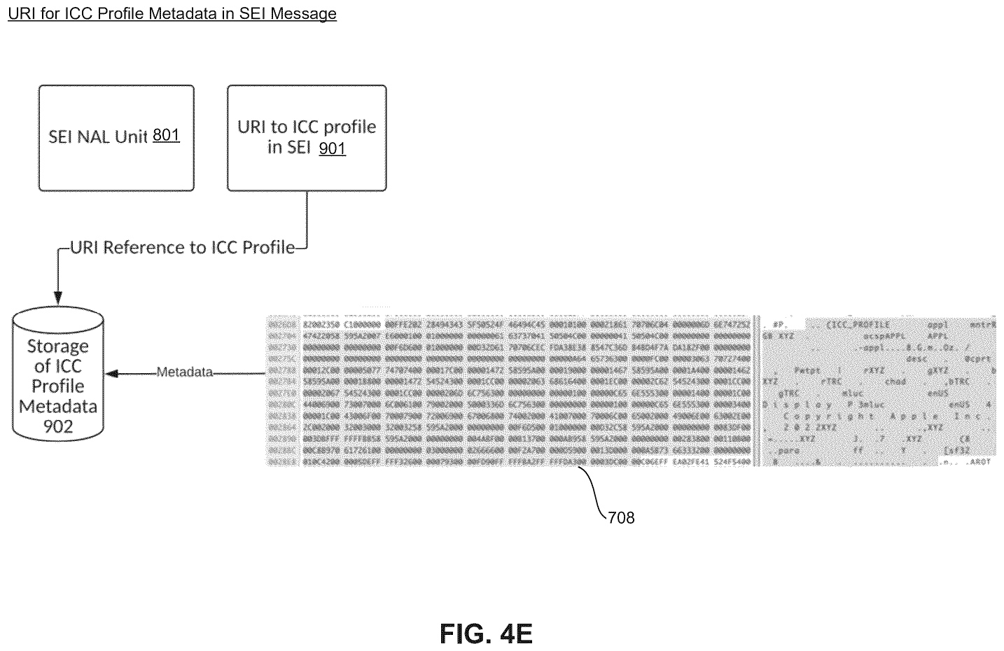

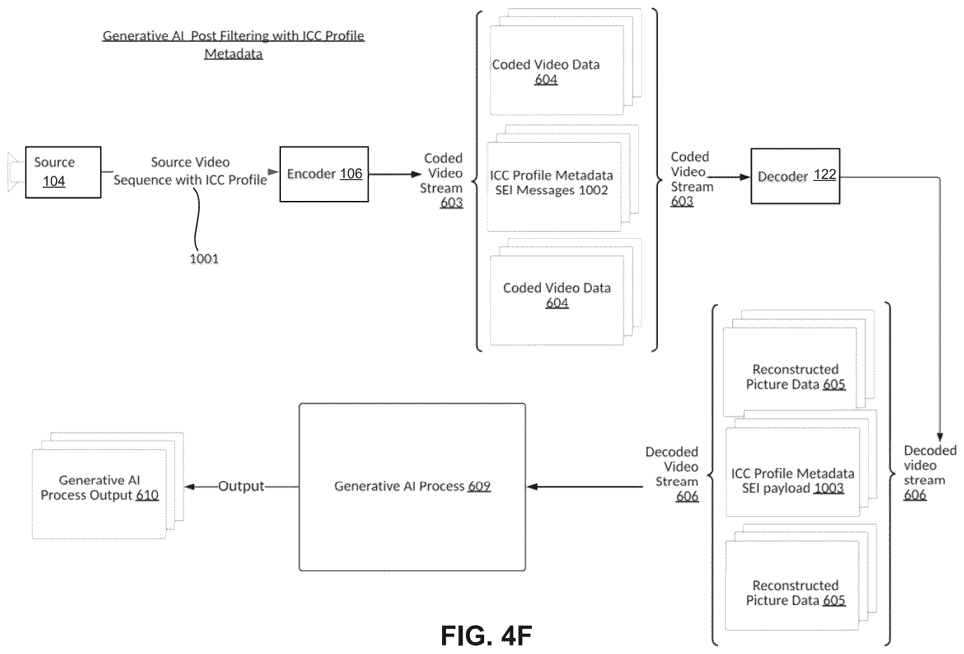

FIG. 4A shows an example layout of a coded video sequence (CVS). The coded video sequence in FIG. 4A is subdivided into network abstraction layer units (NAL units). An example NAL unit 501 includes a NAL unit header 502, which may include one or more reserved bits. In some embodiments, the NAL unit header 502 includes 16 bits, such as a forbidden_zero_bit 503 and nuh_reserved_zero_bit 504, which may be unused and may be zero in a NAL unit. The NAL unit header 502 may further include a nuh_layer_id 505. Several bits of nuh_layer_id 505 (e.g., 3 bits) may be indicative of the layer to which the NAL unit belongs (e.g., spatial, SNR, or multiview enhancement). The NAL unit header 502 may further include a nuh_unit_type 505. Several bits of nuh_nal_unit_type 505 (e.g., 5 bits) indicate the type of NAL unit 501. In some embodiments, 22 NAL unit type values are defined, e.g., 6 NAL unit types are reserved, and 4 NAL unit type values are unspecified and can be used by other specifications (e.g., used outside of the video codec). Several bits of the NAL unit header (e.g., 3) may indicate the temporal layer to which the NAL unit belongs, e.g., nuh_temporal_id_plus1 506.

A coded picture may contain one or more VCL NAL units and/or one or more non-VCL NAL units. VCL NAL units may contain coded data conceptually belonging to a video coding layer as discussed previously. Non-VCL NAL units may contain data not conceptually belonging to the video coding layer. Using H.266 as an example, the NAL units may be categorized into parameter sets, picture headers, NAL markers, prefix/suffix SE NAL units, filler data, and reserved/unspecified NAL unit types.

Parameter sets comprise information that may be necessary for the decoding process and can apply to more than one coded picture. Parameter sets and conceptually similar NAL units may be of NAL unit types such as DCI_NUT (e.g., corresponding decoding capability information (DCI)), VPS_NUT (e.g., corresponding to video parameter set (VPS), establishing, among other things, layer relationships), SPS_NUT (e.g., corresponding to sequence parameter set (SPS), establishing, among other things, parameters used and staying constant throughout a CVS), PPS_NUT (e.g., corresponding to picture parameter set (PPS), establishing, among other things, parameters used and staying constant within a coded picture), and prefix and suffix adaptation parameter sets (e.g., PREFIX_APS_NUT and SUFFIX_APS_NUT). Parameter sets may include information required for a decoder to decode VCL NAL units, and hence may be referred here as “normative” NAL units. A picture header (PH_NUT) may also a considered a “normative” NAL unit.

NAL units marking certain places in a NAL unit stream can include NAL units with the NAL unit types AUD_NUT (e.g., corresponding to an access unit delimiter), EOS_NUT (e.g., corresponding to an end of sequence) and EOB_NUT (e.g., corresponding to an end of bitstream). These NAL units may be considered as non-normative, also known as informative, in the sense that a compliant decoder does not require them for its decoding process, although it needs to be able to receive them in the NAL unit stream.

Prefix and suffix SEI NAL unit types (e.g., PREFIX_SEI_NUT and SUFFIX_SEI_NUT) indicate NAL units containing prefix and suffix supplementary enhancement information. For example, in H.266 those NAL units are considered informative, as they are not required for the decoding process.

Filler data NAL unit type (e.g., FD_NUT) indicates filler data, which is data that can be random and can be used to “waste” bits in a NAL unit stream or bitstream. Such filler data may be necessary for transport over certain isochronous transport environments.

Still referring to FIG. 4A, shown is a layout of a NAL unit stream in decoding order 510 containing a coded picture 511 containing NAL units of some of the types previously discussed. For example, early in the NAL unit stream, DCI 512, VPS 513, and SPS 514 may establish the parameters which the decoder can use to decode the coded pictures of the CVS, including the coded picture 511 of the NAL unit stream.

The coded picture 511 may contain (e.g., in the depicted order or any other order compliant with the video coding technology or standard in use) a prefix-APS 516, a picture header 517, a prefix-SEI 518, one or more VCL NAL units 519, and a suffix-SEI 520.

Prefix and suffix SEI NAL units are used, for some SEI messages, such that the content of the message is known before the coding of a given picture commences, whereas other content is only be known once the picture is coded. Allowing certain SEI messages to appear early or late in a coded picture's NAL unit stream through prefix and suffix SEIs allows for buffering to be reduced/avoided. As an example, in an encoder the sampling time of a picture to be coded is known before the picture is coded, and hence the picture timing SEI message can be a prefix SEI message (e.g., the prefix-APS 516). On the other hand, a decoded picture hash SEI message, which contains a hash of the sample values of a decoded pictures and can be useful, for example, to debug encoder implementations, is a suffix SEI message (e.g., the suffix-SEI 518) as an encoder cannot calculate a hash over reconstructed samples before a picture has been coded. The location of prefix and suffix SEI NAL units may not be restricted to their position in the NAL unit stream. The terms “prefix” and “suffix” imply which coded pictures or NAL units the prefix/suffix SEI messages may pertain to, and the details of this applicability may be specified, for example in the semantics description of a given SEI message.

FIG. 4A also shows a simplified syntax diagram of a NAL unit that contains a prefix or suffix SEI message 520. This syntax is a container format for multiple SEI messages that can be carried in one NAL unit. As with other NAL units, the SEI NAL unit 520 begins with a NAL unit header 521. The header 521 is followed by one or more SEI messages. Two SEI messages, 530-1 and 530-2 are depicted in FIG. 4A. Each SEI message 530 within the SEI NAL unit 520 includes a payload_type_byte 522 (e.g., 8-bits) which may specify which of multiple SEI types applies to the SEI message (e.g., 1 of 256 different SEI types), a payload_size_byte 523 (e.g., 8 bits) which specifies the number of bytes of the SEI payload, and corresponding payloads 524. This structure may be repeated until a payload_type_byte equal to 0×ff is observed, which indicates the end of the NAL unit. The syntax of the payload 524 may depend on the SEI message (e.g., which may have a length between 0 and 255 bytes).

FIG. 4B is a functional block diagram illustrating an example encoding 106 and decoding 122 system that employs an example generative AI post filtering process 609. The system may include a video source 104, e.g., a digital camera, creating a for example source video sequence that is input to the encoder 106. FIG. 4B also shows a separate source 601 of supplemental metadata 602 for the source 104. In some embodiments, the supplemental metadata 602 may be from the video source 104 itself (e.g., as many digital cameras create supplemental metadata in tandem with capturing the source images). FIG. 4B shows the encoder 106 receiving both the supplemental metadata and the source video sequence. The supplemental metadata 602 may be obtained by the encoder 106 from the separate source 601 or it can be obtained directly as the output from the video source 104.

In FIG. 4B, the output from the encoder 106 is a coded video stream 603 comprising one or more sequences of coded picture data 604 and SEI messages 605 that may reference or carry the supplemental metadata 602 in the payload of the SEI messages 605. The coded video stream 603 is input into a decoder 122 that outputs the decoded video stream 606 comprising sequences of reconstructed picture data 607 and payloads 608 of the supplemental metadata SEI messages. The decoded video stream 606 may be input to a generative AI post filtering process 609. The output 610 may be from the generative AI post filtering process 609.

FIG. 4C illustrates a capture system that embeds ICC profile metadata within a JPEG image. Although FIG. 4C illustrates an example with a JPEG image, similar techniques may be used for other types of images. In the figure, a digital camera 701 captures a scene and generates a corresponding JPEG image 705. A first portion of the JPEG image 705 is represented by the sequence of hexadecimal numbers (and corresponding ASCII interpretation) shown in the figure in which ‘0xFFD8’ represents the “Start of Image” JPEG marker 703 as specified in the JPEG image coding standard. A second portion of the JPEG image 705 is represented as a continuation 704 of the JPEG image 705. In this continuation portion 704, an APP2 marker 706 (defined by the sequence ‘0xFFE2’ in the JPEG standard) marks the beginning the ICC Profile metadata 708 (or other types of metadata in other embodiments). The end of the ICC Profile Metadata 707 illustrates the end of the profile metadata, the address of which can be computed by adding 0228 hexadecimal bytes to the address of the APP2 marker.

FIG. 4D illustrates the ICC Profile metadata 708 beginning with the APP2 marker 706 packaged into an SEI message 802 that can be specified by a video standard for the purpose of carrying the ICC Profile metadata payload (and/or other types of payloads) in a coded video stream created by an encoder. In some embodiments, the presence of SEI message 802 is signaled by an SEI NAL unit 801.

FIG. 4E illustrates an SEI message for the carriage of ICC Profile metadata in which the ICC Profile metadata 708 is referenced by a URI 901 from within the payload of SEI message 901. In FIG. 4E, the ICC Profile metadata resides at or in a location 902 that is separate from SEI message.

FIG. 4F illustrates a system that uses ICC Profile metadata embedded within a video sequence 1001 created by a source 104 in a generative AI post filtering process 609. The sequence 1001 from the source 104 is input to the encoder 106. The output from the encoder 106 is a coded video stream 603 comprising, for example, coded video data 604 and ICC Profile metadata SEI messages 1002. The coded video stream 603 is reconstructed by a decoder 122 that outputs a decoded video stream 606. The decoded stream 606 is composed of reconstructed picture data 605 and the ICC Profile metadata payloads 1003. The decoded stream 606 is input to a generative AI process 609 that creates generative AI process output 610.

Table 1 below shows an example syntax for an ICC profile SEI message.

TABLE 1
Example ICC Profile Metadata SEI Message Syntax

| | Descriptor |
|---|---|
| icc_profile_metadata (payloadSize) { | |
| icc_profile_cancel_flag | u(1) |
| icc_profile_mode_id | u(8) |
| if (icc_profile_mode_id == 0) { | |
| for (i = 1; i < payloadSize; i++) | |
| icc_profile_data_payload_byte | b(8) |
| } | |
| else if (icc_profile_mode_id == 1) | |
| icc_profile_data_URI | st(v) |
| } | |

As shown above, a cancel flag (icc_profile_cancel_flag) can be used to disable the persistence of a previously processed ICC Profile SEI message. For example, if icc_profile_cancel_flag is set to a value indicating ‘false’ then the ICC Profile mode ID (icc_profile_mode_id) can indicate whether the payload of the SEI message is the ICC Profile metadata itself or a URI for the location of the ICC Profile metadata. For example, if the mode ID is equal to 0, then the ICC profile data payload byte (icc_profile_data_payload_byte) receives a byte of data from the SEI payload. If the mode ID is equal to 1, then the ICC Profile data URI (icc_profile_data_URI) receives a string of data from the SEI payload.

In some embodiments, different types of image format metadata may be signaled via the SEI messages. For example, the image format types may include an exchangeable image file format (EXIF) type, a JPEG file interchange format (JFIF) type, an extensible metadata platform (XMP) type, an ICC type, and/or a tagged image file format (TIFF) type. An example syntax for SEI messages involving more than one image format type is shown in Table 2.

TABLE 2
Example Image Profile Metadata SEI Message Syntax

| | Descriptor |
|---|---|
| image_format_metadata (payloadSize) { | |
| cancel_flag | u(1) |
| if (!cancel_flag) { | |
| persistence_flag | u(1) |
| num_metadata_payloads | ue(v) |
| for (i = 0; i < num_metadata_payloads; i++) { | |
| type_id [ i ] | ue(v) |
| uri_present_flag [ i ] | u(1) |
| if (!uri_present_flag [ i ]) { | |
| payload_len_minus1 [ i ] | ue(v) |
| while (!byte_aligned( ) ) | |
| bit_equal_to_zero | f(1) |
| for (j = 0; j <= payload_len [ i ]; j++) | |
| data_payload_byte [ i ] [ j ] | b(8) |
| } | |
| else { | |
| while (!byte_aligned( ) ) | |
| bit_equal_to_zero | f(1) |
| data_uri [ i ] | st(v) |
| } | |
| } | |
| } | |

As discussed previously, the cancel flag (cancel_flag) equal to 1 may indicate that the SEI message cancels the persistence of any previous image format metadata SEI message in output order, and the cancel flag equal to 0 may indicate that image format information follows. The persistence flag (persistence_flag) specifies the persistence of the image format metadata SEI message for the current layer. For example, the persistence flag equal to 0 may indicate that the image format metadata SEI message applies only to the current picture, and the persistence flag equal to 1 may indicate that the image format metadata SEI message applies to the current picture and persists for subsequent pictures of the current layer in output order (e.g., until a new CLVS beings or the bitstream ends). The metadata payload numbers variable (num_metadata_payloads) indicates the number of metadata payloads that follow in the SEI message. The zero bit flag (bit_equal_to_zero) should always be zero and serves as a check for the SEI message. The URI present flag (uri_present_flag) indicates whether the metadata is contained within the payload, or the metadata is to be obtained via a URI specified in the payload. For example, if the URI present flag is equal to 0, the image format information may be obtained directly from the payload of the SEI message, and if the URI present flag is equal to 1, the image format information is obtained from using a URI. The payload length variable (payload_len_minus1) indicates the length of the image format information payload. In some embodiments, the payload length (e.g., payload size) is restricted to be less than (or optionally equal to) a threshold value. For example, the payload length may be restricted to be less than 65,535 bytes. The data payload byte (data_payload_byte) contains syntax and semantics for the image format type. For example, when the ICC profile type is indicated, the data payload byte may be used to indicate the ICC version (e.g., major and/or minor version). The data URI variable (data_uri) contains a URI (e.g., with syntax and semantics as specified in IETF Internet Standard 66).

The image format type (type_id) indicates the type of metadata payload for the SEI message. For example, a value of 0 may indicate the EXIF type, a value of 1-3 may indicate a JFIF type, a value of 4 may indicate the XMP type, and a value of 5 may indicate an ICC profile type.

In some embodiments, the image format (e.g., ICC profile) SEI message is a prefix SEI message. For example, the SEI payload may be specified as show in Table 3 below.

TABLE 3
Example Syntax for SEI Payload

Descriptor

```
  sei_payload (payloadType, payloadSize) {
    SeiExtensionBitsPresentFlag = 0
      if (nal_unit_type == PRFIX_SEI_NUT)
        if (payloadType == 0)
          buffering_period (payloadSize)
        else if (payloadType == 1)
          pic_timing (payloadSize)
. . .
        else if (payloadType == 227)
          image_format_metadata (payloadSize)
. . .
}
```

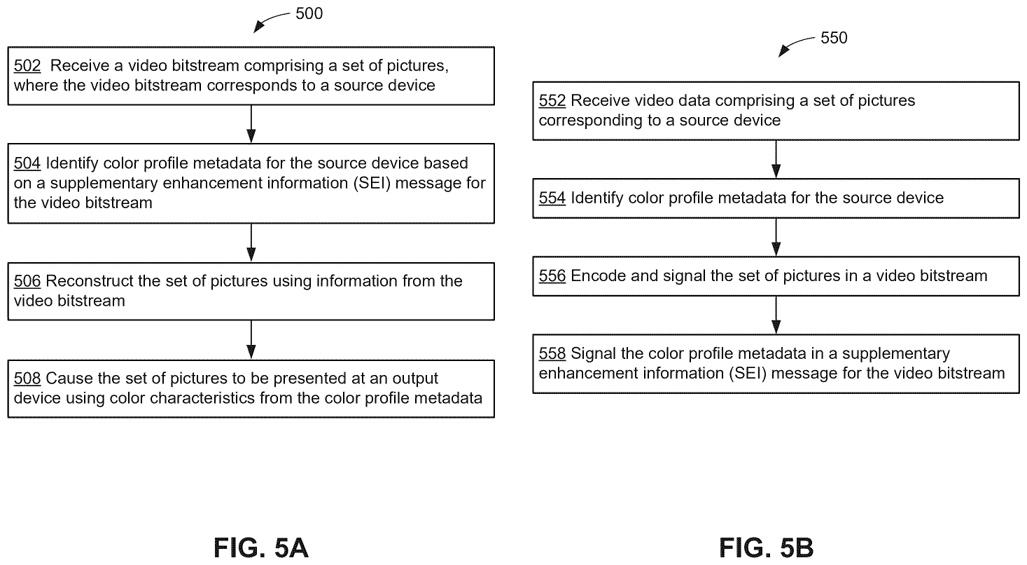

FIG. 5A is a flow diagram illustrating a method 500 of decoding video in accordance with some embodiments. The method 500 may be performed at a computing system (e.g., the server system 112, the source device 102, or the electronic device 120) having control circuitry and memory storing instructions for execution by the control circuitry. In some embodiments, the method 500 is performed by executing instructions stored in the memory (e.g., the memory 314) of the computing system.

The system receives (502) a video bitstream (e.g., a coded video sequence) comprising a set of pictures, where the video bitstream corresponds to a source device (e.g., the source device 102). The system identifies (504) color profile metadata (e.g., image format metadata) for the source device based on an SEI message for the video bitstream. The system reconstructs (506) the set of pictures using information from the video bitstream. The system causes (508) the set of pictures to be presented at an output device using color characteristics from the color profile metadata. In some embodiments, the color profile metadata comprises ICC metadata (e.g., an ICC profile). In this way, ICC metadata may be extracted from or referenced by a SEI message.

FIG. 5B is a flow diagram illustrating a method 550 of encoding video in accordance with some embodiments. The method 550 may be performed at a computing system (e.g., the server system 112, the source device 102, or the electronic device 120) having control circuitry and memory storing instructions for execution by the control circuitry. In some embodiments, the method 550 is performed by executing instructions stored in the memory (e.g., the memory 314) of the computing system.

The system receives (552) video data (e.g., a source video sequence) comprising a set of pictures corresponding to a source device (e.g., the source device 102). The system identifies (554) color profile metadata for the source device. The system encodes and signals (556) the set of pictures in a video bitstream. The system signals (558) the color profile metadata in an SEI message for the video bitstream. As described previously, the encoding process may mirror the decoding processes described herein (e.g., signaling and parsing additional data for a video bitstream). For brevity, those details are not repeated here.

Although FIGS. 5A and 5B illustrates a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments:

(A1) In one aspect, some embodiments include a method (e.g., the method 500) of video decoding. In some embodiments, the method is performed at a computing system (e.g., the server system 112) having memory and one or more processors. In some embodiments, the method is performed at a coding module (e.g., the coding module 320). The method includes: (i) receiving a video bitstream (e.g., a coded video sequence) comprising a set of pictures, where the video bitstream corresponds to a source device; (ii) identifying color profile metadata (and/or other image format metadata) for the source device based on an SEI message for the video bitstream; (iii) reconstructing the set of pictures using information from the video bitstream; and (iv) causing the set of pictures to be presented at an output device using color characteristics from the color profile metadata. For example, the SEI message may contain ICC profile metadata. As an example, the SEI message may be included as part of the video bitstream obtained from an image source.

An advantage of using color metadata (e.g., an ICC profile) is that it provides a mechanism to unambiguously map the video stream to an output-referred color space whereas color information in the video stream is insufficient to perform such a mapping. Mapping to the output color space may be particularly important in circumstances where the video is being displayed on a computer display where the fidelity may otherwise be degraded.

(A2) In some embodiments of A1, the method further comprising parsing an image format metadata (IFM) type identifier that indicates a type of metadata included in the SEI message, wherein the color profile metadata is identified when the IFM type identifier indicates that the SEI message contains the color profile metadata. For example, the IFM types may include Exif, JFIF, XMP, ICC, TIFF, and/or other types of metadata.

(A3) In some embodiments of A1 or A2, the color profile metadata comprises an International Color Consortium (ICC) profile. For example, information stored in International Color Consortium (ICC) profile specifications, which may likewise be published by ISO as ISO 15076.

(A4) In some embodiments of A3, the color profile metadata indicates an ICC major version number and an ICC minor version number. For example, a first variable (ICCmajorVer) may be set equal to data_payload_byte [i] [8]>>4 and a second variable (ICCminorVer) may be set equal to data_payload_byte [i] [9]>>4 and are interpreted as the ICC profile major and minor versions.

(A5) In some embodiments of any of A1-A4, the color profile metadata is obtained from a payload of the SEI message. For example, the metadata may be stored directly into the payload of an SEI message according to the capabilities of the video coding standards.

(A6) In some embodiments of any of A1-A4, the SEI message includes a uniform resource identifier (URI) string for the color profile metadata. For example, an SEI message can be created with a URI that identifies the exact ICC profile metadata resource to be obtained from a source external to the video bitstream. As an example, the ICC Profile metadata may reside at or in a location separate from the SEI message.

(A7) In some embodiments of any of A1-A6, the method further comprises applying a filtering process to the set of pictures using the color profile metadata. In some embodiments, the filtering process is a generative artificial intelligence (AI) filtering process, e.g., as illustrated in FIG. 4F.

(A8) In some embodiments of any of A1-A7, the video bitstream corresponds to a source video sequence comprising image data and the color profile metadata. For example, a first portion of an image can be represented by the sequence of hexadecimal numbers (e.g., as specified in the JPEG image coding standard) and a second portion of the same image can include profile metadata for the image.

(A9) In some embodiments of any of A1-A8, the method further comprises determining that the SEI message is present based on a syntax element in a network abstraction layer (NAL). For example, the presence of an SEI message may be signaled by an SEI NAL unit. In some embodiments, the SEI message is parsed only when the NAL indicates that the SEI message is present. In some embodiments, in accordance with a determination that the NAL indicates that the SEI message is not present, causing the set of pictures to be presented without identifying the color profile metadata.

(A9) In some embodiments of any of A1-A9, the SEI message includes a first indicator indicating whether a previously-processed SEI message of a same type is not to be persisted. For example, a cancel flag can be used to disable the persistence of a previously processed ICC Profile SEI message. The first indicator may be referred to as a cancel flag (e.g., an icc_profile_cancel_flag or cancel_flag).

(A10) In some embodiments of A9, the method further comprises, when the first indicator indicates that that the previously-processed SEI message is to be persisted, determining whether to obtain the color profile metadata from a payload of the SEI message or a URI according to a second indicator. For example, an ICC Profile mode ID can indicate whether the payload of the SEI message is the ICC Profile metadata itself or a URI for the location of the ICC Profile metadata. The second indicator may be referred to as a URI flag (e.g., a uri_present_flag or icc_profile_mode_id).

(B1) In another aspect, some embodiments include a method (e.g., the method 550) of video encoding. In some embodiments, the method is performed at a computing system (e.g., the server system 112) having memory and one or more processors. In some embodiments, the method is performed at a coding module (e.g., the coding module 320). The method includes: (i) receiving video data (e.g., a source video sequence) comprising a set of pictures corresponding to a source device; (ii) identifying color profile metadata for the source device; (iii) encoding and signaling the set of pictures in a video bitstream; and (iv) signaling the color profile metadata in an SEI message for the video bitstream.

(B2) In some embodiments of B1, the color profile metadata comprises an International Color Consortium (ICC) profile.

(B3) In some embodiments of B1 or B2, the color profile metadata is signaled in a payload of the SEI message.

(B4) In some embodiments of any of B1-B3, the SEI message includes a uniform resource identifier (URI) string for the color profile metadata. For example, the SEI message may include a payload with some metadata and a URI with additional metadata.

(B5) In some embodiments of any of B1-B4, the video data comprises image data and the color profile metadata.

(B6) In some embodiments of any of B1-B5, the method further comprises signaling whether the SEI message is present in a network abstraction layer (NAL) of the video bitstream.

(B7) In some embodiments of any of B1-B6, the method further comprises signaling, via a first indicator in the SEI message, whether a previously-processed SEI message of a same type is not to be persisted.

(C1) In another aspect, some embodiments include a method of processing visual media data. In some embodiments, the method is performed at a computing system (e.g., the server system 112) having memory and one or more processors. In some embodiments, the method is performed at a coding module (e.g., the coding module 320). The method includes: (i) obtaining a source video sequence that comprises a plurality of frames; and (ii) performing a conversion between the source video sequence and a video bitstream of visual media data according to a format rule, where the video bitstream comprises a plurality of encoded frames and the format rule specifies that: (a) color profile metadata is to be obtained for the set of pictures using SEI message for the video bitstream; and (b) the plurality of encoded frames are to be reconstructed using color characteristics from the color profile metadata.

(D1) In another aspect, some embodiments include a method of video processing. In some embodiments, the method is performed at a computing system (e.g., the server system 112) having memory and one or more processors. In some embodiments, the method is performed at a coding module (e.g., the coding module 320). The method includes: (i) setting an image format metadata type identifier to indicate that ICC profile metadata is included in an SEI message associated with a current image; (ii) signaling the image format metadata type identifier in a bitstream; and (iii) encoding the current image in the bitstream based on the image format metadata type identifier.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., A1-A10, B1-B7, C1, and D1 above). In yet another aspect, some embodiments include a non-transitory computer-readable storage medium storing one or more sets of instructions for execution by control circuitry of a computing system, the one or more sets of instructions including instructions for performing any of the methods described herein (e.g., A1-A10, B1-B7, C1, and D1 above).

Unless otherwise specified, any of the syntax elements described herein may be high-level syntax (HLS). As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, N refers to a variable number. Unless explicitly stated, different instances of N may refer to the same number (e.g., the same integer value, such as the number 2) or different numbers.

As used herein, the term “if” can be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of video decoding performed at a computing system having memory and one or more processors, the method comprising:
receiving a video bitstream comprising a set of pictures, wherein the video bitstream corresponds to a source device;
identifying color profile metadata for the source device based on a supplementary enhancement information (SEI) message for the video bitstream;
reconstructing the set of pictures using information from the video bitstream; and
causing the set of pictures to be presented at an output device using color characteristics from the color profile metadata.

2. The method of claim 1, further comprising parsing an image format metadata (IFM) type identifier that indicates a type of metadata included in the SEI message, wherein the color profile metadata is identified when the IFM type identifier indicates that the SEI message contains the color profile metadata.

3. The method of claim 1, wherein the color profile metadata comprises an International Color Consortium (ICC) profile.

4. The method of claim 3, wherein the color profile metadata indicates an ICC major version number and an ICC minor version number.

5. The method of claim 1, wherein the color profile metadata is obtained from a payload of the SEI message.

6. The method of claim 1, wherein the SEI message includes a uniform resource identifier (URI) string for the color profile metadata.

7. The method of claim 1, further comprising applying a filtering process to the set of pictures using the color profile metadata.

8. The method of claim 1, wherein the video bitstream corresponds to a source video sequence comprising image data and the color profile metadata.

9. The method of claim 1, further comprising determining that the SEI message is present based on a syntax element in a network abstraction layer (NAL).

10. The method of claim 1, wherein the SEI message includes a first indicator indicating whether a previously-processed SEI message of a same type is not to be persisted.

11. The method of claim 10, further comprising, when the first indicator indicates that that the previously-processed SEI message is to be persisted, determining whether to obtain the color profile metadata from a payload of the SEI message or a URI according to a second indicator.

12. A method of video encoding performed at a computing system having memory and one or more processors, the method comprising:
receiving video data comprising a set of pictures corresponding to a source device;
identifying color profile metadata for the source device;
encoding and signaling the set of pictures in a video bitstream; and
signaling the color profile metadata in a supplementary enhancement information (SEI) message for the video bitstream.

13. The method of claim 12, wherein the color profile metadata comprises an International Color Consortium (ICC) profile.

14. The method of claim 12, wherein the color profile metadata is signaled in a payload of the SEI message.

15. The method of claim 12, wherein the SEI message includes a uniform resource identifier (URI) string for the color profile metadata.

16. The method of claim 12, wherein the video data comprises image data and the color profile metadata.

17. The method of claim 12, further comprising signaling whether the SEI message is present in a network abstraction layer (NAL) of the video bitstream.

18. The method of claim 12, further comprising signaling, via a first indicator in the SEI message, whether a previously-processed SEI message of a same type is not to be persisted.

19. A non-transitory computer-readable storage medium storing a video bitstream that is generated by a video encoding method, the video encoding method comprising:
receiving video data comprising a set of pictures corresponding to a source device;
identifying color profile metadata for the source device; and
encoding the set of pictures; and
wherein the video bitstream comprises the encoded set of pictures and a supplementary enhancement information (SEI) message that indicates the color profile metadata.

20. The non-transitory computer-readable storage medium of claim 19, wherein the SEI message contains the color profile metadata or indicates a storage location of the color profile metadata.
